(19) United States
(12) Patent Application Publication
(10) Pub. No.: US 2003/0021924 A1
(43) Pub. Date: Jan. 30, 2003

(54) Fireproof repository

(76) Inventors: Kurara Sakamoto, Okayama (JP); Takeshi Ario, Okayama (JP); Toshio Miyake, Okayama (JP)

Correspondence Address: Browdy And Neimark, 624 Ninth Street N W, Washington, DC, 20001-5303, US

(21) Appl. No.: 10/148,546

(22) PCT Filed: Oct. 2, 2001
(86) PCT No.: PCT/JP01/08681

(30) Foreign Application Priority Data
Oct. 6, 2000 (JP) 308309/2000
May 22, 2001 (JP) 152946/2001
Jun. 26, 2001 (JP) 193674/2001
Apr. 2, 2001 (JP) 201446/2001

(51) Int. Cl. B32B 1/02

(52) U.S. Cl. 428/35.2

(57) ABSTRACT

The object of the present invention is to provide a fireproof container which prevents the quality deterioration of articles to be stored when exposed to a relatively high temperature condition and which has a satisfactory transportability; the above object is solved by providing a fireproof container characterized in that it comprises a container portion having partially an opening part and a lid means capable of sealing the opening part to keep the inner space of the container portion in a sealed condition and optionally capable of making the inner space into an open condition, where the container portion comprises a multilayer structure of three outer-, middle- and inner-layers positioning in this order from the outside to the inside of the container portion, wherein in the multilayer structure the outer layer comprises a fire-resistant insulating material having a bulk specific gravity of not higher than 1.0 g/cm³, the middle layer comprises a material having an air-spaced layer and/or endothermic property, and the inner layer comprises a incombustibility material having a bulk specific gravity of not higher than 2.0 g/cm³.

### TECHNICAL FIELD

The present invention relates to a novel fireproof container, more particularly, a fireproof container having a satisfactory fire resistivity that inhibits quality deterioration of articles to be stored (designated as “storing articles”, hereinafter) even when exposed to a relatively high temperature condition.

### BACKGROUND ART

In fireproof containers such as conventional fire-resistant containers, the heat capacity (multiplication of specific heat and mass) of walls of the fireproof containers is gained by using, as materials for the walls, a quantity of materials with a relatively large mass and specific heat such as concrete. Because of this, the gross weight of the fireproof containers becomes too high. Independently of business and household uses and if only the desired fireproof ability will be attainable, such an increased gross weight tends to be rather acceptable for fireproof containers, which are to be used for storing valuable articles such as money, valuable metals, and securities, in view of antitheft. Therefore, the weight saving of fireproof containers has not been focussed on so much until now.

However, even a fireproof container with an outstandingly high fire resistivity would never secure the stable keeping of storing articles when the container is encountered with fire having no promising time for fire extinction such as fire of tower blocks and other fires accompanied by earthquakes and volcanic eruptions. To deal with such disasters, the only way is to bring out fireproof containers from places at fire as quick as possible, however, conventional types of extensively heavily fireproof containers are substantially impossible to be brought out quickly, depending on disaster conditions. Such a problem will be overcome by the establishment of a fireproof container with properties of sufficient fire resistivity and advantageous transportability.

In these days with an increased concerning on articles having property values such as art objects, there has been an increased demand for safe storing of such articles which are possessed privately or publicly. Accordingly, the present inventors studied on the effectiveness of fire resistivity of fireproof containers in general now used widely for use in storing such articles. As a result, they found that the fire resistivity of conventional fireproof containers such as those “for papers in general use” specified in JIS S 1037:1998, Fire-resistive container(s) (designated as “JIS Fire-resistive container(s), hereinafter), in Japanese Industrial Standards, revised on Mar. 20, 1998, published by Japanese Standards Association, can hold storing articles to an extent that it allows the articles to be recognized as what they are even after having been exposed to relatively high-temperature conditions but is not necessarily sufficient for use in storing art objects and the like which should be avoided from quality deterioration. Based on these, the present inventors concluded that there is a great potential need for fireproof containers having both advantageous fire resistivity of inhibiting quality deterioration of storing articles and transportability applicable to the above situations in fire and the like.

In addition, though it is not so many, there are some proposals for fireproof containers with an improved transportability. For example, a lightweight portable fireproof container as disclosed in Registered Japanese Utility Model No. 3,033,602, and a fireproof container disclosed in Japanese Patent Kokai No. 61,323/98 can be mentioned. As evident from a disclosure in the item of “Effect of the Present Utility Model” in the former specification, i.e., “The fireproof container of the present utility model has enabled to completely protect articles in a fireproof container from fire with only allowing the container to place in a conventional, widely-used, relatively low cost fireproof container.”, the former fireproof container has an advantageous transportability but is hard to say that it exerts a sufficient fire resistivity when used alone. While, as evident from a disclosure in the item of “Object of the Invention” of the latter specification, i.e., “By imparting an advantageous fire resistivity and lowering the weight as much as possible, a fireproof container with an improved handleability is provided.”, the characteristic feature of the above proposal resides in the attainment of weight saving of the container but not distinctive improvement of its fire resistivity. Also, these proposals could not be said to have sufficient actual utility. As described above, the fact is that, in spite of the potential demand, there has not yet been established any fireproof container possessing both advantageous fire resistivity of preventing the quality deterioration of storing articles and the desired transportability applicable to the aforesaid situations in fire and the like.

### DISCLOSURE OF INVENTION

In view of the foregoing background, the object of the present invention provides a fireproof container possessing both fire resistivity of preventing the quality deterioration of storing articles and advantageous transportability.

First, the present inventors confirmed in a preliminarily experiment that, as described above, the ability of acceptable inner temperature of 177° C. or lower, which is of the fire-resistive container “for papers in general use” specified in JIS Fire-resistive container(s), is thoroughly insufficient for storing art products and the like, whose quality deterioration should be avoided, to meet the fire resistivity aimed at by the present invention. Then, the present inventors energetically studied to establish a fireproof container which far exceeds the above fire resistivity of conventional fireproof containers and has advantageous transportability.

However, as far as the present inventors' tests with various combinations of materials generally used in conventional fireproof containers, no sufficiently acceptable fireproof container was obtained. Accordingly, the present inventors had changed their conception, then focused on materials other than those used in conventional fireproof containers and further continued studying. As a result, they found that the aimed fireproof container that sufficiently overcomes the object of the present invention is obtained by forming a fireproof container with a multilayer structure of three outer-, middle- and inner-layers positioning in this order from the outside to the inside of the container; wherein in the multilayer structure a layer, as the outer layer, comprising a fire-resistant insulating material having a bulk specific gravity of not higher than 1.0 g/cm³, which has not been used as a partial structure of fireproof containers, is employed in combination with another layer, as the middle layer, comprising a material having an air-spaced layer and/or endothermic property and the other layer, as the inner layer, comprising an incombustibility material having a bulk specific gravity of not higher than 2.0 g/cm³. The present invention was made based on this complete self-finding by the present inventors.

Thus, the present invention solves the object of the present invention by providing a fireproof container comprising a container portion having partially an opening part and a lid means capable of sealing the opening part to keep the inner space of the container portion in a sealed condition and optionally capable of making the inner space into an open condition, where the container portion comprises a multilayer structure of three outer-, middle- and inner-layers positioning in this order from the outside to the inside of the container, the outer layer comprises a fire-resistant insulating material having a bulk specific gravity of not higher than 1.0 g/cm³, the middle layer comprises a material having an air-spaced layer and/or endothermic property, and the inner layer comprises an incombustibility material having a bulk specific gravity of not higher than 2.0 g/cm³.

### BRIEF DESCRIPTION OF DRAWINGS

FIG. 1 is a drawing of endothermic property of hydrous crystalline trehalose.

FIG. 2 is a standard temperature curve for the standard heat test specified in JIS Fire-resistive container(s).

FIG. 3 is a typical drawing of longitudinal sectional view of an embodiment of the fireproof container of the present invention, i.e., the fireproof container A in Example 1.

FIG. 4 is a typical drawing of longitudinal sectional view of another embodiment of the fireproof container of the present invention, i.e., the fireproof container B in Example 1.

FIG. 5 is a typical drawing of longitudinal sectional view of the other embodiment of the fireproof container of the present invention, i.e., the fireproof container C in Example 1.

FIG. 6 is a drawing of the changes of inner temperatures of the fireproof containers A, B and C of the present invention and of containers X₁ and X₂ as controls when subjected to the 1-hour standard heat test.

FIG. 7 is a typical drawing of longitudinal sectional view of another embodiment of the fireproof container of the present invention in Example 2.

FIG. 8 is a typical drawing of longitudinal sectional view of another embodiment of the fireproof container of the present invention in Example 3.

FIG. 9 is a typical drawing of longitudinal sectional view of another embodiment of the fireproof container of the present invention in Example 4.

FIG. 10 is a typical drawing of longitudinal sectional view of another embodiment of the fireproof container of the present invention in Example 5.

FIG. 11 is a typical perspective view of outlook of the fireproof container in Example 5 when the container portion and the lid means of the fireproof container exist independently.

Explanation of symbols

| | |
|---|---|
| 1 | Container portion |
| 1a | Outer layer |
| 1b | Inner layer |
| 1c | Middle layer |
| 1d | Spacer |
| 1e | Agent for inhibiting the increase of temperature |
| 1f | Moistureproof layer |
| 1g, 1h | Outermost layer |
| 2 | Lid means |
| 2a | Layer of lid means corresponding to outer |
| | layer in container portion |
| 2b | Layer of lif means corresponding to inner |
| | layer in container portion |
| 2c | Layer of lid means corresponding to middle |
| | layer in container portion |
| 2d | Spacer in lid means corresponding to spacer in |
| | container porrtion |
| 2f | Layer of lid means corresponding to moistureproof |
| | layer in container portion |
| 2g, 2h | Layer of lid means corresponding to outermost |
| | layer in container portion |
| 3 | Storing article |

### BEST MODE OF THE INVENTION

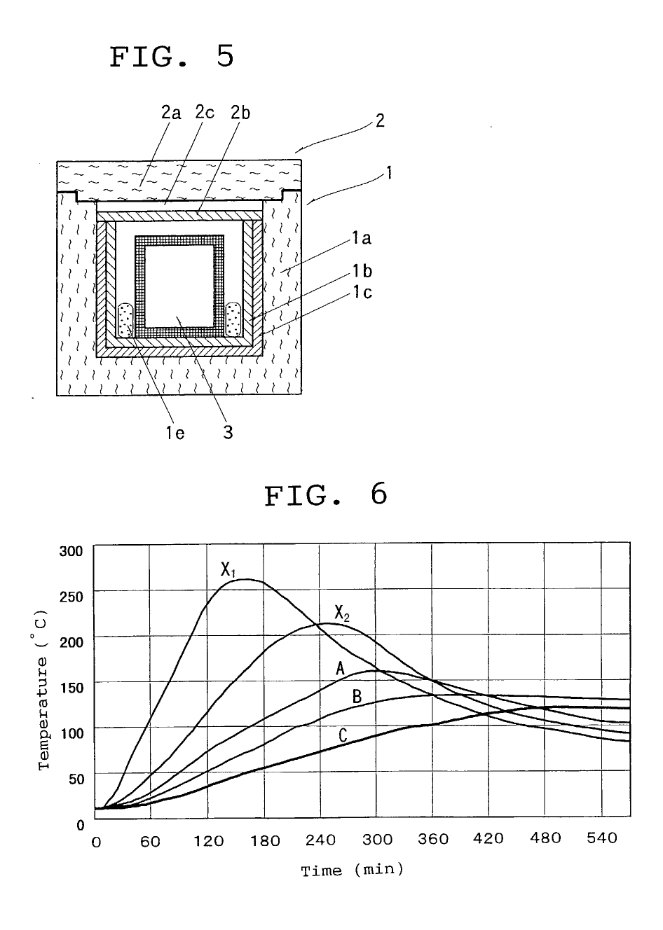

As shown in FIG. 4 for a typical drawing of longitudinal sectional view of an embodiment of the fireproof container of the present invention, the fireproof container is characterized in that it comprises a container portion 1 having partially an opening part and a lid means 2 capable of sealing the opening part to keep its inner space in a sealed condition, and optionally capable of making the inner space into an open condition, where the container portion 1 comprises a multilayer structure of at least three layers of an outer layer 1a, middle layer 1c, and inner layer 1b positioning in this order from the outside to the inside of the container, wherein in the multilayer structure the outer layer 1a comprises a fire-resistant insulating material having a bulk specific gravity of not higher than 1.0 g/cm³, the middle layer 1c comprises a material having an air-spaced layer and/or endothermic property, and the inner layer 1b comprises an incombustibility material having a bulk specific gravity of not higher than 2.0 g/cm³. In the embodiment of FIG. 4, the lid means 2 comprises each independent materials of an outer lid means constructed by a layer 2a corresponding to the outer layer 1a in the container portion 1. When used by sealing the opening part of the container portion 1 with the independent materials, a space between the layers 2a and 2b forms a layer 2c corresponding to the middle layer 1c in the container portion 1. Also, in FIG. 4, the symbol 3 shows a storing article.

As long as the outer layer in the multilayer structure for forming the container portion of the fireproof container is a layer comprising a fire resistant material and having a bulk specific gravity of not higher than 1.0 g/cm³, preferably, not higher than 0.5 g/cm³, and more preferably, not higher than 0.4 g/cm³, and being capable of exerting the effect to solve the object of the present invention, any layers either consisting of single material or comprising different materials can be used without specific restriction of their properties and chemical compositions of the materials used. Although the minimum bulk specific gravity of the outer layer is not specifically restricted from a viewpoint of transportability of the fireproof container, it is preferably be set to a level, usually, at least 0.2 g/cm³, preferably, at least 0.25 g/cm³, from a viewpoint of keeping the physical strength of the fireproof container. Regarding the thermal property as another preferable property of the outer layer, it can be exemplified, for example, a thermal property that does not substantially lose the inherent mechanical strength of the outer layer when and/or after exposed to temperature conditions of, usually, up to 1,000° C., preferably, up to 1,200° C.; while regarding the heat insulating property, it can be exemplified a heat insulating property that usually shows a coefficient of thermal conductivity of 0.15 W/(m·k) or lower, preferably, 0.12 W/(m·k) or lower at 600° C. When the outer layer has an adequate flexibility of absorbing external shock, it may be advantageous in installing an outermost layer on the outside of the outer layer as described later. As an example of the fire resistive insulating materials usable in the present invention, ceramic fibers, aluminum fibers, and ceramics such as lightweight ceramic products disclosed in Japanese Patent Kokai No. 109,381/00, can be mentioned; these materials can be used in practicing the present invention in such a manner of allowing them to form over the above layers having the above properties. In addition, “ISOWOOL® 1260 BOARD”, a commercialized ceramic fiber board, produced by Isolite Insulating Products Co., Ltd., Tokyo, Japan, and the like can be advantageously used in practicing the present invention because they have been formed into layers or plates having the aforesaid properties. The thickness of the outer layer is appropriately chosen depending on the structure of other layers used in combination, the types and kinds of storing articles to be placed, and the fields of the fireproof containers to be used. For example, in the case of using fireproof containers having an outer layer of the aforesaid commercialized products as containers for business or household use, the thickness of the outer layer is usually at least 10 mm, preferably, 20-400 mm, and more preferably, 50-200 mm.

Regarding the inner layer in the multilayer structure for forming the container portion of the fireproof container of the present invention, any layers can be used in the present invention without restricting to specific property and chemical composition of the materials used as long as the layers have usually a bulk specific gravity of 2.0 g/cm³ or lower, preferably, 0.15-1.5 g/cm³, and more preferably, 0.8-1.2 g/cm³, and exert the effect of solving the object of the present invention. Such layers may be those made of a single substance or a composition of substances. Regarding the incombustibility of the inner layer, those which do not substantially ignite or catch fire under temperature conditions, usually, of 800° C. or lower, preferably, 1,000° C. or lower, can be preferable. The inner layer usable in the present invention is preferably those which attain a desired heat capacity within a limitation that does not affect the transportability. In addition to the above bulk specific gravity, the suitable property for keeping the desired heat capacity is an adequate thermal conductivity, usually, of 0.6 W/(m·k) or lower, preferably, 0.4 W/(m·k) or lower at 350° C. As an example of the materials for incombustibility usable in the present invention, it can be mentioned, for example, insulating firebricks that fulfill the standard C-1 specified in “Insulating Firebrick”, JIS R 2611:1992, in Japanese Industrial Standards, revised on May 1, 1992. Such insulating firebricks can be used after processed into the desired shapes depending on needs. For example, “ISOLITE C-1”, a product of Isolite Insulating Products Co., Ltd., Tokyo, Japan, can be arbitrarily used as a commercialized product that fulfills the above standard. The thickness of the inner layer is appropriately set depending on the structure of other layers used in combination, the kind/type of storing articles to be placed, and the field of the fireproof containers to be used, etc. For example, in the case of the fireproof containers comprising inner layers of the above commercialized products used as containers for business or household use, the thickness of the inner layer is, usually, at least 1 mm, preferably, 2-40 mm, more preferably, 5-20 mm.

The multilayer structure which forms the container portion of the fireproof container of the present invention further comprises a middle layer positioning between the above outer- and inner-layers. The middle layer is a layer which comprises a material having an air layer and/or the desired endothermic property. When such an air layer is provided as the middle layer, an appropriate spacer(s) is placed between the outer- and inner-layers in conventional manner. The installation of the air layer as the middle layer is particularly advantageous to improve the transportability of the fireproof container.

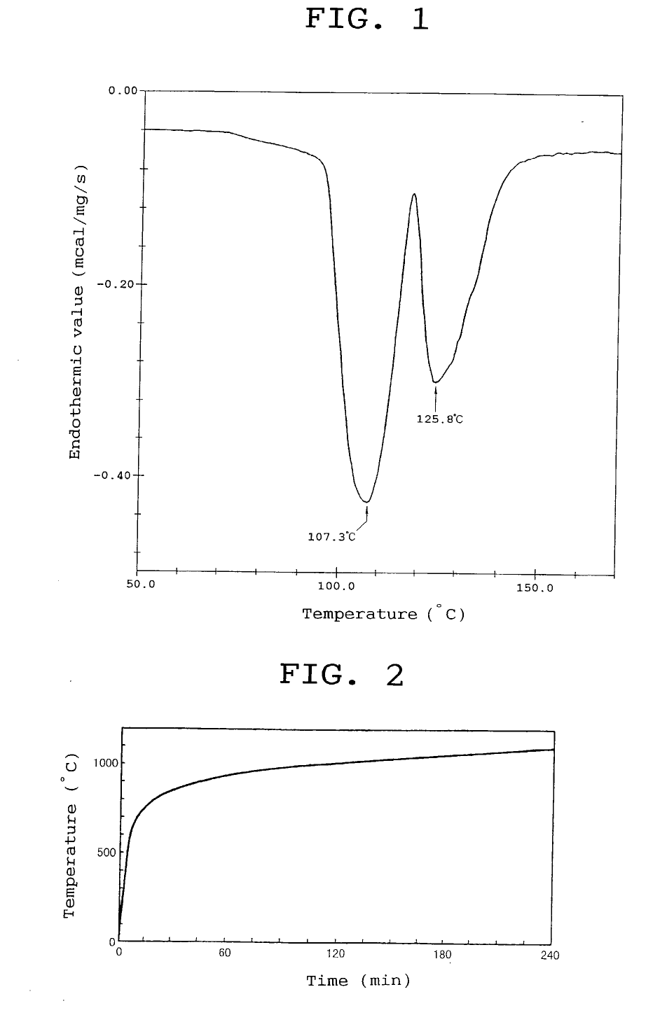

While in the case of installing as the middle player a layer comprising a material with the desired endothermic property, the fire resistivity of the fireproof container is more improved. Any materials can be used as the above material as long as they exert the effect of solving the object of the present invention when formed into the middle layer of the fireproof container without restriction of their property and chemical composition and independently of being made of a simple substance or a composition of substances. The materials with the desired endothermic property usable in the present invention include, for example, organic- or inorganic-materials having an endothermic property of generating an endothermic reaction at temperatures, usually, of about 80 to about 200° C., preferably, about 90 to about 150° C. without being influenced by humidity. Examples of the organic materials usable in the present invention include, particularly, sodium thiosulfate, disodium hydrogenphosphate, and sodium sulfate. The organic materials usable in the present invention include, particularly, mono- and oligo-saccharides such as glucose, maltose, lactose, trehalose (α,α-trehalose which may be abbreviated as “trehalose” hereinafter, if specified otherwise), neotrehalose (α,β-trehalose), raffinose, rhamnose, and lactulose; sugar alcohols such as erythritol, xylitol, sorbitol, maltitol, and lactitol; cyclodextrins such as α-, β-, γ-cyclodextrins, and glycosyl derivatives thereof; and other saccharides such as cyclotetrasaccharide and glycosyl derivatives thereof, where the cyclotetrasaccharide is disclosed as “cyclic tetrasaccharide” along with its detailed crystalline structure by G. M. Bradbrook in Carbohydrate Research, Vol. 329, pp. 655-665 (2000). Among these materials, those which can exist in the form of a hydrous crystal or hydrate are particularly useful in practicing the present invention because they have also a property of exerting an endothermic property and inhibiting the internal drying of the container portion by releasing their bound water. In addition to the above endothermic property, since more preferably used are materials having a lesser danger of generating poisonous gasses when heated, the aforesaid saccharides with the desired endothermic property can be particularly advantageously used in the present invention because they have a relatively lesser fear of generating poisonous gasses. One of the particularly preferable materials, which can be mentioned in view of the above aspect, is a hydrous crystalline trehalose, for example, a commercially available saccharide, “TREHA®”, a product commercialized by Hayashibara Shoji Inc., Okayama, Japan. Regarding this, FIG. 1 shows a result of the endothermic property, i.e., the endothermic value per hour and per weight, of a hydrous crystalline trehalose using the above commercialized product, measured on a differential scanning calorimeter under an increasing temperature condition of 10° C./min within a temperature range of 50 to 170° C. The result shows that hydrous crystalline trehalose has an advantageous endothermic property in practicing the present invention. To form the middle layer using the aforesaid materials, for example, one or more materials, selected appropriately depending on purposes, would have been previously formed into multilayer products using appropriate binders or injected into the space provided between the above outer- and inner-layers. The thickness of the middle layer is appropriately set in view of the structure of other layers used in combination, the kind/type of storing articles to be placed, and the fields of the fireproof containers to be used. For example, in the case of the fireproof containers used as containers for business or household use, the thickness of their middle layer is usually set to at least 1 mm, preferably, 2 to 40 mm, and more preferably, 5 to 20 mm. Also, in the fireproof container of the present invention, either of the following structures can be employed; a structure, as the middle layer, constructed by two layers of the above-mentioned air layer and another layer comprising a material(s) having the desired endothermic property, where the layers are closely adjacent each other, or the structure comprising partially a material(s) having the desired endothermic property, for example, the structure of a layer comprising such a material(s) imparted with appropriate voids.

Although the multilayer structure for forming the container portion of the fireproof container of the present invention has basically the above structure, an outermost layer can be optionally provided on the outside of the above outer layer of the fireproof container of the present invention. For example, when an outermost layer made of a metal or ceramic is provided, the outer layer of the fireproof container can be avoided from a direct flame when in fire and the like, resulting in a more effective prevention of increasing the inner temperature as a merit. Such an outermost layer also exerts a function of protecting the inner structure from external shocks. In the case of providing a metallic or ceramic layer as the outermost layer, when the fireproof container is subjected to temperature changing conditions, a force is actuated on its internal layer, for example, the outer layer of the above container portion by the difference of expansion coefficients of the metallic layer and the inner structure, and this may result in deforming the inner layer or inducing cracks and then affecting the inhibition of inner temperature increase. Such a problem would be overcome by using a thinnest possible layer as the outermost layer and making the thinnest layer into a structure which contacts, but not completely, with the surface of the inner layer. Alternatively, such a problem can be overcome by providing either an insulating layer with flexibility and fire resistivity on the surface of the inner layer adjacent to the outermost layer or making the inner layer adjacent to the outermost layer into a layer formed with a material with adequate flexibility. The thickness of the outermost layer is appropriately selected depending on the type/kind of the materials used: For example, when materials with relatively high thermal tolerance having, usually, heat tolerance up to a temperature of 1,000° C. are used in a ceramic layer, the resulting ceramic layer should have a thickness of about 1 to 20 mm, preferably, 5 to 10 mm; when copper or aluminum is used as a material for a metal layer, the resulting layer should have a thickness of about 2 mm or lower; and when iron or stainless steel is used as a material for a metal layer, the resulting layer should have a thickness of about 0.5 mm or lower. With these conditions, there exert advantageous features of improving the fire resistivity and shock tolerance and effectively avoiding the above problems. In the case of not installing the outermost layer or of providing, as the outermost layer, layers made of sheets with moisture permeability such as papers, cloths, and woods, the resulting fireproof container has a characteristic feature that the inner moisture level in the container portion can be controlled by changing the external circumstances under ambient temperature condition. By providing, as the outermost layer, layers made of materials such as papers, cloths and woods which can be appropriately colored, the fireproof container can be easily modified with the desired colors or paintings.

In addition to the above multilayer structure, a moistureproof layer is advantageously provided between the outer- and middle-layers, if necessary. For example, the fireproof container would be watered during fire fighting when in fire, and therefore, when the middle layer of the fireproof container is made of an organic- or inorganic-material, such a material dissolves in water when watered and then flows out of the middle layer, and this would possibly affect the function of the fireproof container or hinder the recycling thereof. Such a problem can be avoided by installing the above-mentioned moistureproof layer. The materials and functions of the moistureproof layer have no restriction as long as they do not hinder the function of the fireproof container of the present invention; in this regard, aluminum foil-laminated sheets and the like can be advantageously used.

If necessary, in the fireproof container of the present invention, another layer(s) which does or does not fulfil the requirement of either of these layers can be optionally installed in a part or the whole of one or more rooms/spaces formed between any of two layers of the above outermost-, outer-, moistureproof-, middle-, and inner-layers; and a space of the inside of the inner layer. By employing such a structure, a more improved fire resistivity can be attained, although it somewhat deteriorates the transportability of the fireproof container. For example, the fireproof resistivity of the fireproof container can be more improved by installing layers of calcium silicate or foam concrete as a relatively advantageous incombustible material into an appropriate space, usually, either of internal rooms/spaces formed between layers in the inside of the outer layer, preferably, in the inside of and adjacent to the outer layer. Depending on the shape as described later, the fireproof container may occasionally have a high-temperature local site when exposed to heating conditions, and therefore, the fire resistivity in such a local site to be assumed can be advantageously reinforced by providing partially the aforesaid another layer(s). Actually, depending on conditions, the corner portions of the middle- and inner-layers of the fireproof container may give a higher temperature than the other middle- and inner-layers, however, such a problem can be avoided by installing the aforesaid another layer in the portions corresponding to the corner portions or preferably installing an outermost layer made of a material with fire resistivity.

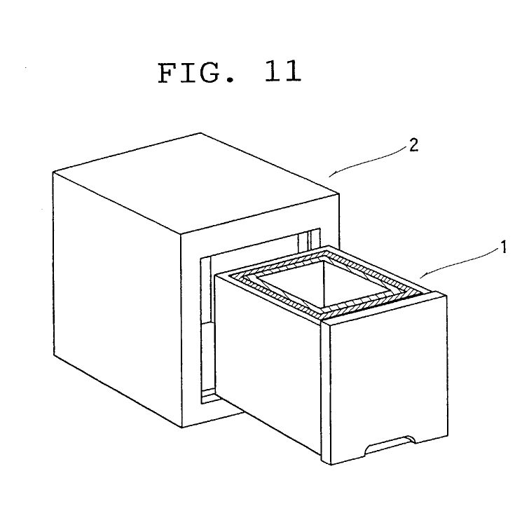

The container portion of the fireproof container of the present invention is formed by the multilayer structure described above. As long as the container portion is formed by the above multilayer structure when made into a sealed condition internally by combining with a lid means having partially an opening part and being capable of sealing the opening part, any procedure for forming the container portion and any structure thereof in a separate condition from the lid means can be used. For example, the container portion is formed by providing previously a structure with the desired shape in the form of a plain plate having the aimed multilayer structure, and constructing the structure as a material part into the desired shape in the form of a box and the like having partially an opening part. Alternatively, the container portion can be formed by providing previously a structure with the desired shape in the form of a box having partially an opening part, and sequentially layering onto the structure other layers of middle- and inner-layers. Furthermore, in the case of employing a structure prepared by making a lid means 2, as shown in FIGS. 10 and 11 as the whole structure of the fireproof container, into a box shape having partially an opening part, and then inserting a container portion 1 into the lid means 2 to make the internal part of the container portion into a sealed condition, the container portion 1 existing separately from the lid means 2 should not necessary have all of the three outer-, middle- and inner-layers in a part corresponding to the part of the lid means having the desired layers, if only the desired layers corresponding to the outer-, middle- and inner-layers in the container portion are provided in the lid means 2. The shape of the container portion should not be restricted to a specific one and, in view of the type/kind of storing articles to be applied and the total design, it can be appropriately selected from columnar, conical, square, pyramidal, and spherical shapes, as well as a box shape. The position of the opening part in the container portion is appropriately selected from the top-, side- and bottom-faces depending on use.

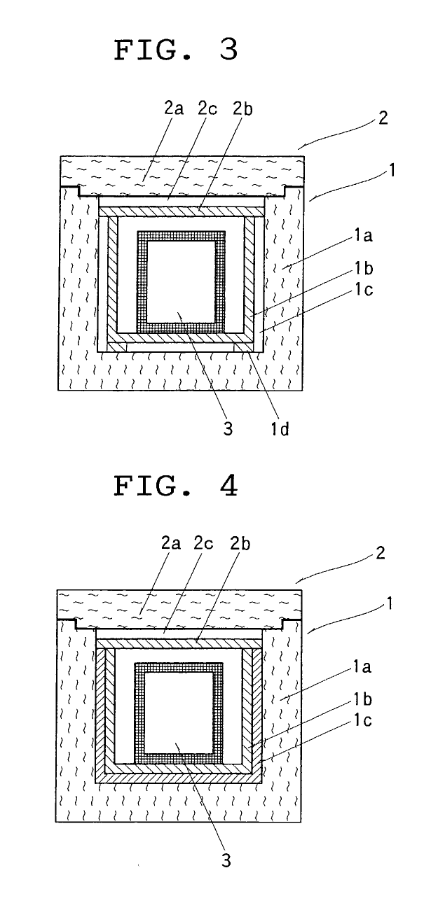

The lid means of the fireproof container of the present invention is a structure capable of sealing the opening part of the container portion as mentioned above to keep the internal part in a sealed condition, and of making the internal part into an open condition depending on need. Although the lid means should preferably has the same multilayer structure as in the above-mentioned container portion, the multilayer structure can be partially omitted or modified within the limitation of not losing the effect of solving the object of the present invention when in use, depending on the shape and function of the container portion and the area of the opening part in the portion. For example, a lid means having a multilayer structure comprising a layer corresponding to the outer layer of the above-mentioned container portion, optionally a layer(s) corresponding to the middle- and/or inner-layers, and more optionally a layer(s) corresponding to the outermost- and/or moistureproof-layers can be usually advantageously used as the lid means of the present invention. Furthermore, similarly as the outer- and inner-lids, the lid means can be constructed into a structure comprising at least two independent lid means materials having either of the above-mentioned layers. In this case, each lid means materials can be arbitrarily made into either a structure where they are closely attached together, or a structure where an appropriate space is provided between them: In the latter structure, the space will exert a similar function as in the air layer in the middle layer of the container portion. The shape of a lid means for making the internal part of the container portion into a sealed condition and the method therefor can be appropriately selected, depending on the shape of the container portion and the lid means, within the limitation that they do not affect the effect of solving the object of the present invention. For example, to a container portion having an opening part on the top face, a lid means like a lid means 2 as shown in FIGS. 3 to 5 and FIGS. 7 to 9 is formed to close each opening part in each container without any gap and then placed on the container portions from their upper sides, resulting in attaining a sealed condition in the container portions. Similarly as in the lid means 2 respectively shown their longitudinal sectional views and perspective views of FIGS. 10 and 11, the desired sealed condition is attained by inserting the container portion into the lid means when the lid means is formed in such a manner of surrounding the periphery of the container portion without any gap and then forming into a box shape having partially an opening part. Independently of the position of the opening part of the container portion, the sealed condition or the open condition of the container portion can be appropriately attained without separating the lid means and the container portion by forming the lid means into a shape such as a plate shape capable of sealing the opening part and then installing the resulting lid means in either end of the opening part of the container portion using a metal part, etc., to allow the lid means to be freely opened or closed. If necessary, the fireproof container of the present invention thus obtained can be arbitrarily installed with handles or wheels to improve its transportability, or imparted with a lock function.

The fireproof container thus constructed has usually improved transportability and a fire resistivity far exceeding the function of “1-hour fire resistivity for papers in general” that is confirmed when subjected to “1-hour standard heat test” defined in “JIS Fire-resistive container(s)”. Explaining briefly the standard heat test in the above definition, first, provide a furnace as a heating furnace for test which gives a time-dependent thermal change along the standard thermal curve in FIG. 2 substantially uniformly over the whole surface except for the bottom part of a test product (a fireproof container), when a test product is placed therein. Then, place in the furnace the test product provided previously with a thermometer or thermo couple in or on the surface of the furnace, and then heat the test product in the furnace to change the surface temperature of the test product along the standard thermal curve. During the heating, the inner temperature of the test product is measured at appropriate times. When a prescribed time has passed, terminate the heating, gradually allow to cool, and then measure the inner temperature of the test product. Depending on the time period before termination of heating, it is called, for example, “1-hour standard heat test”, “2-hour standard heat test”, etc. The performance of “1-hour fire resistivity for papers in general”, defined in the above definition, means an ability that keeps the peak of the inner temperature at temperatures not exceeding 177° C. during the heating for one hour according to the standard heat test, and then cooling the heated test product until the lowering of the inner temperature is observed. The fireproof container of the present invention has an ability that keeps its inner temperature at temperatures distinctively below 177° C., usually, not higher than 165° C., preferably, not higher than 150° C., and more preferably, not higher than 130° C. under the 1-hour standard heat test. In addition to this fire resistivity, the fireproof container has also a satisfactory transportability. Varying depending on the capacity or the ability, conventional 20 L-fireproof containers for papers in general have a total weight of at least 80 kg or at least 100 kg, however, the fireproof container of the present invention with a capacity equivalent to conventional ones weighs usually 40 kg or lower, preferably, 20 kg or lower, and more preferably, 10 kg or lower.

The above-mentioned fireproof container of the present invention is particularly useful as a container for storing articles, which are directed to be handled by conventional fireproof containers, such as notes, coins, valuables, securities, muniments, as well as those which should be avoided from quality deterioration, for example, art products including valuable antiques such as paintings, scroll pictures, ceramics, porcelains, lacquer wares, swords, body armors, and ancient documents; and flushable/ignitable substances and articles. The structure of the fireproof container of the present invention disclosed in the specification can be applied to structures other than containers for storing articles. Examples of such applications include containers for transporting articles with different sizes such as personal use suit cases and containers for automobiles, ships and passenger airplanes; boxes for enclosing, storing or arranging articles for personal and business use; bodies for electronic appliances; and structures for enclosing electronic appliances in constructions. Since the fireproof container of the present invention has a character of lightweight, the structure of the container is applicable to larger-sized constructions. For example, by applying the structure according to the present invention to wall materials in constructions, constructions in general and others such as storehouses for storing articles which should be avoided from quality deterioration, or an additional room in constructions can be formed; or by employing the structure of the fireproof container according to the present invention as a structure for enclosing skeleton framings or earthquake-resistive devices in constructions, particularly, high buildings, the main part products of these constructions can be protected from fire. In addition, when employed in the structure of bodies of transporting means such as automobiles, ships and airplanes, the structure of the present invention improves their fire resistivity; and when employed in the structure of the body of spaceships such as space shuttles, which are repeatedly used in traveling between the inner and outer atmosphere, the structure of the present invention would advantageously inhibit the increase of inner temperature of the spaceships when plunging into the atmosphere. The structure of the fireproof container of the present invention can be applied to structures where the shielding of heat from articles/substances with a potential heat generation or in a high temperature condition. For example, the application of the structure of the fireproof container of the present invention to the structure for enclosing electric products with a potential heat generation and to the structure for factories which handle articles/substances with a potential heat generation or for a room in the factories can minimize the level or range of disasters caused by abrupt heat generation from such articles/substances. In this case, the directional/positional arrangement in the multilayer structure in the fireproof container can be arbitrarily reversed. When prepared previously is a multilayer product in a plain shape having a structure corresponding to the multilayer structure for constituting the container portion of the fireproof container, the multilayer product per se can be made into a refractory panel usable in various fields; such a panel can be used as a material for the fireproof container of the present invention, material for the aforesaid containers for transportation, construction material for the above-mentioned constructions, and structure material of the body of the above-mentioned spaceships.

The above materials having endothermic property used in the fireproof container, particularly, saccharides exert a distinctive effect of solving the object of the present invention when constructed into the fireproof container as a part, and exert the desired endothermic property when used separately from the fireproof container. Because of these, they can be advantageously used alone, for example, as an agent for inhibiting the increase of temperature (may be designated as “temperature increase preventive”, hereinafter), in such a manner of being placed in the container portion. Based of the fact, the present invention provides an agent for inhibiting the increase of temperature comprising a saccharide(s) as an effective ingredient. Any ingredients in any forms can be used in the temperature increase preventive of the present invention, as long as the preventive comprises one or more of the above saccharides and stands in a condition capable of exerting the inherent thermal property. For example, the temperature increase preventive is provided in the form of a composition either consisting of the above saccharide(s) or others comprising the above saccharide(s) and at least one of pigments, fragrances, deodorants, moth-proofing agents, fungicides, and moisture-absorbers, where the content of the saccharide(s) is usually at least 80%, and preferably, 90-100% by weight. The temperature increase preventive of the present invention can be optionally provided in a form prepared by injecting the saccharide(s) into bags prepared by sewing fabrics, non-fabrics or the like prepared with materials having moisture-permeability and/or flexibility such as Japanese/Chinese papers, natural fibers, synthetic fibers, and fireproof fibers. When used by placing in the fireproof container, the temperature increase preventive preferably contains the saccharide(s) in an amount, usually, of about 1 to about 1,000 g, preferably, about 10 to about 500 g, varying dependently on the size of the fireproof container and the kind/type of storing articles. By placing one or more of the above temperature increase preventives of the present invention in conventional fireproof containers or in the fireproof container of the present invention depending on the volume of each of the container portions, the increase of inner temperature of these containers will be more effectively inhibited. Of course, the temperature increase preventive of the present invention can be used by placing in constructions other than fireproof containers, it can be advantageously practiced in such a manner of placing in containers for transporting articles, constructions, or in a room of the constructions to inhibit the increase of inner temperature thereof when externally heated, or inversely in such a manner of placing in constructions for storing/transporting articles/substances with a potential heat generation to inhibit their heat emission to the outside of the constructions. In addition to the use in walls for fireproof constructions, the temperature increase preventive can be used as a partial material for transporting means in general such as automobiles, ships, and airplanes, as well as for the body of spaceships such as space shuttles used repeatedly in traveling between the inner and outer atmosphere, to improve the fire resistivity of the constructions per se; or used as a partial material for constructing an enclosing structure for imparting fire resistivity to skeleton framings and earthquake-resistive devices in constructions, to improve the fire resistivity of the enclosing structure.

Also, the present invention provides a temperature increase preventive construction, comprising, at least as a partial construction material, the temperature increase preventive of the present invention. The term “temperature increase preventive construction(s)” as referred to as in the present invention means a construction(s) capable of shielding or inhibiting the heat conduction from heat sources or a part of the construction(s): For example, the term means panels and sheets, as well as containers, bags, and the like with different sizes and shapes prepared with the panels and sheets. The term “comprises at least as a partial construction material” as referred to as in the present invention means that the temperature increase preventive constructs the above temperature increase preventing construction alone or in combination with another material(s), where the preventive should preferably be contained in the construction in such a manner of being contactable with the outside air. For example, as for the panels, constructions prepared by injecting the temperature increase preventive of the present invention into the space formed between two plate products made of a desired material(s) such as ceramic fibers, aluminum fibers, insulating firebricks, potteries, aerated concretes, woods, and papers including cardboards and corrugated fiberboards; sealing around the periphery of opening of the plate products; attaching the temperature increase preventive, injected into bags with the desired sizes and shapes, onto a part or the whole surface of plate products made of the desired material; or piling up both the temperature increase preventives, which have been previously formed in a plate form using an adequate adhesive, and a desired plate product into multilayer products. As for the above-described sheets, constructions prepared by sewing fabrics, non-fabrics, sheets or the like made of the desired materials into bag-shaped products; injecting the temperature increase preventive into the products; and optionally further sewing the products into quilting-like products or sewing the temperature increase preventives, which have been injected into bags with the desired sizes and shapes, onto a part or the whole surface of the desired fabrics, non-fabrics, sheets or the like. By using the above-mentioned constructions as a partial material and forming them into containers or bags with the desired shapes, the following products can be made: Containers, depositories, storages, transporting containers and the like usable for storing, housing, or transporting articles which should be avoided from temperature increase and, reversely, those which have a potential heat generation. The temperature increase preventive constructions in the form of a panel or sheet according to the present invention can be arbitrarily used as construction materials for larger-sized constructions, automobiles, ships, airplanes, airships, spaceships, and the like.

The following experiments and examples describe the present invention in more detail:

Experiment: Quality Deterioration of Storing Articles by Heating

Samples were subjected to the following heat test to examine the quality deterioration of papers, woods, and cloths, which are the main ingredients for material property such as art products and are poor in fire resistivity, when subjected to heating conditions. As samples, 14 samples in the Table 1 below having a rectangular shape with a size of 6 to 7 cm in length and 7 to 10 cm in wide, and, for wood specimens, having a thickness of about one centimeter, were used. The heating of the samples was carried out by keeping them in an electric furnace adjusted to any of temperatures, as inner temperatures, in Table 1 for respective periods of time while being hung with metal rods and kept not to contact with the walls of the furnace. The evaluation of the test was done based on the microscopic observation by five persons who engaged in art museums, where the samples after the heat treatments were evaluated in five ranks with respect to standard samples with no heat treatment: The symbol “⊚” means that no substantial quality deterioration is found; “0”, quality deterioration is found but quite slight; “Δ”, relatively clear quality deterioration is found but acceptable as the quality change of art products that is inescapable of secular change; “x”, clear quality deterioration is found and unacceptable even though considering the quality change of art products inescapable from secular change; and “xx”, high level of quality change is found and thoroughly unacceptable. The evaluations shown by most of the panels are tabulated in Table 1. The evaluation results were judged to be sufficiently reliable because each result in Table 1 was one well coincided with those of at least four panels out of five.

TABLE 1

| Temperature | 120° C. | | | 130° C. | | | 140° C. | | |
|---|---|---|---|---|---|---|---|---|---|
| Time | 2 hr | 6 hr | 24 hr | 2 hr | 6 hr | 24 h | 2 hr | 6 hr | 24 hr |
| Copying paper | ◯ | ◯ | Δ | Δ | Δ | X | ◯ | X | XX |
| Thin paper | ◯ | ◯ | ◯ | ◯ | ◯ | Δ | ◯ | ◯ | Δ |
| Pure Shikoku daphne | Δ | Δ | X | Δ | Δ | X | Δ | Δ | XX |
| Hemp paper | Δ | Δ | X | Δ | Δ | X | Δ | X | XX |
| Pure paper Mulberry | ⊚ | ⊚ | ⊚ | ⊚ | ◯ | Δ | ◯ | ◯ | Δ |
| Wara-gasen-shi (a Chinese drawing paper) | ◯ | ◯ | Δ | ◯ | ◯ | X | ◯ | Δ | X |
| Pure Trident daphne | ◯ | Δ | Δ | ◯ | Δ | X | ◯ | Δ | X |
| Woods | | | | | | | | | |
| Japanese cedar | ⊚ | ⊚ | Δ | ⊚ | ◯ | Δ | ⊚ | ◯ | Δ |
| Japanese cypress | ⊚ | ⊚ | ◯ | ⊚ | ⊚ | ◯ | ⊚ | ⊚ | ◯ |
| Paulownia | ⊚ | ◯ | ◯ | ◯ | ◯ | ◯ | ◯ | Δ | X |
| Cotton cloth | ⊚ | ⊚ | ⊚ | ⊚ | ⊚ | ◯ | ⊚ | ⊚ | ◯ |
| Ramie cloth | ⊚ | ⊚ | ◯ | ⊚ | ◯ | ◯ | ◯ | ◯ | Δ |
| Silk | ◯ | ◯ | Δ | ◯ | ◯ | X | ◯ | Δ | X |
| Silk (sized) | Δ | Δ | X | Δ | Δ | X | Δ | X | X |

As evident form Table 1, it was revealed that the papers, woods and cloths generally showed no or a passable range of quality deterioration up to 130° C. when heated within six hours, and most of them excluding some papers had a roughly acceptable range of quality deterioration even when heated at about 140° C. These results show that the fireproof ability of acceptable inner temperature of 177° C. in fireproof containers for general papers defined in “JIS Fire-resistive container(s)”, i.e., the fireproof ability of fireproof containers now widely used well, is not necessarily sufficient as a fireproof ability for storing articles which should be avoided from quality deterioration.

### EXAMPLE 1

### Fireproof Container and its Fireproof Ability

### Example 1-1

### Fireproof Container

As an embodiment of the fireproof container of the present invention, a fireproof container A, having the structure shown in typically with its longitudinal sectional view of FIG. 3, was prepared. As shown in FIG. 3, in a container portion 1 in the fireproof container A, an outer layer 1a is a layer, having 100 mm in thickness, made of “ISOWOOL® 1260 BOARD”, a ceramic fire board as a fireproof insulation material commercialized by Isolite Insulating Products Co., Ltd., Tokyo, Japan; an inner layer 1b is a layer having 10 mm in thickness made of “ISOLITE C-1”, an insulating firebrick as an incombustible material commercialized by Isolite Insulating Products Co., Ltd., Tokyo, Japan; and a middle layer 1c is an air layer, having 10 mm in thickness, provided via a spacer 1d made of the above insulating firebrick. A lid means 2 is composed of an inner lid, comprising a layer 2b having 10 mm in thickness, which is made of the above insulating firebrick corresponding to the inner layer 1b, placeable on the inner layer 1b, and in the form of plate with an appropriate size capable of keeping the inner part of the container portion 1 in a sealed condition; and an outer layer, comprising a layer 2a having 100 mm in thickness, which is made of the above insulating firebrick corresponding to the outer layer 1a, and has an appropriate size suitably placeable on the outer layer 1a at a distance of 10 mm apart from the inner layer. As shown in FIG. 3, when the inner and outer lids as part products of the lid means 2 are provided on the opening part of the container portion 1, a space formed between the lids results in a layer 2c corresponding to the middle layer 1c of the container portion 1. When the lid means 2 is provided on the container portion 1, the fireproof container A has the following sizes: 63 cm in wide, 59 cm in depth, and 40 cm in height, where the term “wide” means the right and left directions with respect to those on the paper of FIG. 3, and the term “depth” means the vertical direction with respect to the surface of the paper of FIG. 3. Throughout FIGS. 3 to 5 and FIGS. 7 to 10, the symbol 3 shows a storing article.

As an another embodiment of the fireproof container of the present invention, a fireproof container B, having the structure shown in typically with its longitudinal sectional view of FIG. 3, was prepared. As shown in FIG. 4, the fireproof container B has totally the same structure as of the fireproof container A except that a middle layer 1c, having 10 mm in thickness, which is made of a hydrous crystalline trehalose powder (“TREHA®” commercialized by Hayashibara Shoji Inc., Okayama, Japan), as a material with a desired endothermic property, was provided by injecting the powder into the space formed between the outer and inner layers, in place of the middle layer containing the spacers in the container portion of the fireproof container A.

As a still another embodiment of the fireproof container of the present invention, a fireproof container C, having the structure shown in typically with its longitudinal sectional view of FIG. 5, was prepared. As shown in FIG. 5, the fireproof container C has totally the same structure as of the fireproof container B except that 1,246 g by weight of a hydrous crystalline trehalose powder, as a temperature increase preventive 1e, which had been injected into a silk bag, was placed in the container portion 1.

As controls the following were made: A container X₁ consisting of the outer layer and the outer lid having 100 mm in thickness each as in the fireproof container A; and a container X₂ having the same structure as of the container X₁ except for making both the outer layer and the outer lid to give a thickness of 120 mm.

### Example 1-2

### Standard Heat Test

The fireproof containers A, B and C in the above example and the containers X₁ and X₂ as controls were subjected to the 1-hour standard heat test specified in “JIS Fire-resistive container(s)” to examine the inner temperature change of their container portions. The results are in FIG. 6. In FIG. 6, the curves A, B and C are respectively the inner temperature changes for the fireproof containers A, B and C; and the curves X₁ and X₂ are respectively those for the container portions X₁ and X₂. In this test, a box of Paulownia wood as a model of storing article was placed in each container portion and, after completion of the test, the condition of the boxes were macroscopically observed.

As shown in FIG. 6, the peak of inner temperature of the fireproof container A was about 160° C., and those of the fireproof containers B and C were respectively about 130° C. and about 120° C. With regard to the condition of the boxes of Paulownia wood, the fireproof container A gave a slight partial color change of the box but did not burn it, and the boxes in the fireproof containers B and C showed no substantial quality change. These results show that the fireproof containers of the present invention have an ability far exceeding the ability of “1-hour fireproof of papers in general”, i.e., an ability of keeping the inner temperature of 177° C. or lower on the 1-hour standard heat test, specified in “JIS Fire-resistive container(s)”; and among of these fireproof containers, the fireproof containers with layers, as middle layers, made of materials with a desired endothermic property are particularly advantageous for storing articles including art products which should be avoided from quality deterioration. While the containers X₁ and X₂ as controls, their inner temperatures far exceeded over 200° C., and the boxes of Paulownia wood had totally burned brown. As evident from the results, in the case of constructing a container with only the outer layer according to the present invention, the fire resistivity tends to be improved by increasing the thickness of the layer, however, it must be made into a layer with a highly larger thickness to attain the desired fire resistivity. Therefore, the above results indicate that the structure consisting of the outer layer according to the present invention could not substantially solve the object of the present invention. Also as found in FIG. 6, in the above heat test, the times, at which the inner temperatures of the fireproof containers A, B and C of the present invention reached their peaks, were all later than those of the containers X₁ and X₂ as controls. This means that the fireproof containers of the present invention afford the time needed until they are brought out when in fire.

### EXAMPLE 2

### Fireproof Container

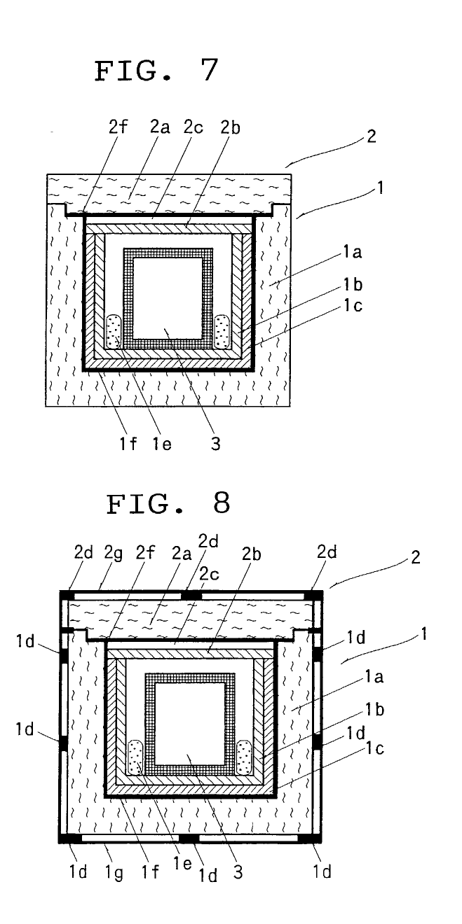

A fireproof container, having the structure shown in typically with its longitudinal sectional view of FIG. 7, according to the present invention, was prepared. As shown in FIG. 7, the fireproof container has totally the same structure as of the fireproof container C in Example 1 except that moistureproof layers 1f and 2f, made of a laminated aluminum foil, were respectively placed between the outer layer 1a and the middle layer 1c in the container portion 1, and on the surface of the layer 2a in the lid means, facing to the side of the container portion 1.

The product has advantageous fire resistivity and transportability, will not be affected even when sprayed with water due to fire fighting when in fire, and also has the merit that it can be reused even after sprayed with water.

### EXAMPLE 3

### Fireproof Container

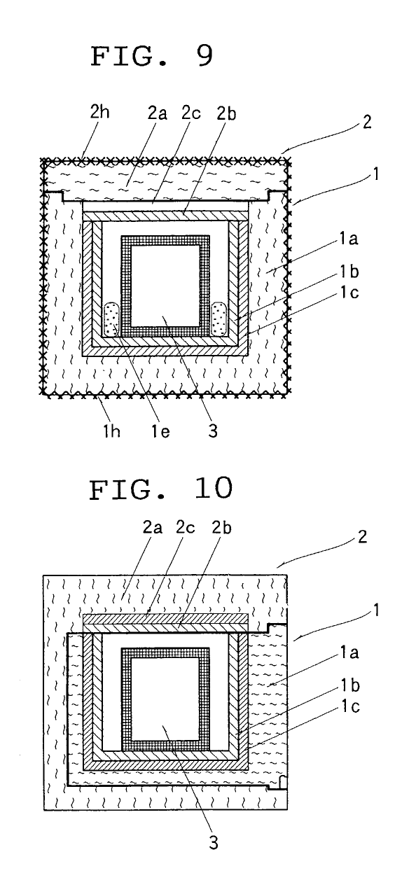

A fireproof container, having the structure shown in typically with its longitudinal sectional view of FIG. 8, according to the present invention, was prepared. As shown in FIG. 8, the fireproof container has totally the same structure as of the fireproof container in Example 2 except that the outermost layers 1g and 2g, having 1.5 mm in thickness, made of aluminum, were provided outside of an outer layer via aluminum block spacers 1d and 2d.

The product has good durability against direct fire, has advantageous fire resistivity and transportability, will not be affected even when sprayed with water due to fire fighting when in fire, and also has the merit that it can be reused even after sprayed with water.

### EXAMPLE 4

### Fireproof Container

A fireproof container, having the structure shown in typically with its longitudinal sectional view of FIG. 9, according to the present invention, was prepared. As shown in FIG. 9, the fireproof container has totally the same structure as of the fireproof container C in Example 1 except that the outermost layers 1h and 2h, made of a moisture permeable cloth, were provided outside of an outer layer.

The product has advantageous fire resistivity, transportability, and fine spectacle, and similarly as the fireproof container C with no outermost layer, it has the merit that the moisture within the container portion can be controlled by regulating the outer circumstance while storing articles.

### EXAMPLE 5

### Fireproof Container

A fireproof container, having the structure shown in typically with its longitudinal sectional view of FIG. 10 and its perspective view of FIG. 11, according to the present invention, was prepared. As shown in FIG. 10, in the container portion 1 of the fireproof container, an outer layer 1a is a layer made of “ISOWOOL® 1260 BOARD” commercialized by Isolite Insulating Products Co., Ltd., Tokyo, Japan; an inner layer 1b is a layer, having 10 mm in thickness, made of “ISOLITE C-1”, an insulating firebrick as an incombustible material commercialized by Isolite Insulating Products Co., Ltd., Tokyo, Japan; and a middle layer 1c is a layer of “TREHA®”, a hydrous crystalline trehalose powder commercialized by Hayashibara Shoji Inc., Okayama, Japan, having 10 mm in thickness, prepared by injecting the powder into the space formed between the outer layer 1a and the inner layer 1b. A lid means 2 surrounds the whole outer surface of a container portion 1 without gap, has a box-like form with a partial opening part, and comprises a layer 2a corresponding to the outer layer 1a of the container portion 1, and layers 2b and 2c, corresponding to the inner layer 1b and the middle layer 1c of the container portion 1, respectively, which are provided on the surface that contacts with the opening part of the container portion 1. The outer layer of the fireproof container in this example has a thickness of 100 mm as of the container portion or the lid means, or of the container portion plus the lid means.

Since the product has advantageous transportability and a structure for inserting the container portion into the lid means, it can keep the sealed condition in the container portion at a higher level, resulting in a characteristic exertion of particularly advantageous fire resistivity.

### EXAMPLE 6

### Temperature Increase Preventive

Two sheets, having about 10-cm-square, of a satin silk cloth, were sewed together except for leaving only a pair of sides, into a bag-shaped product which was then injected with “TREHA®”, a hydrous crystalline trehalose powder commercialized by Hayashibara Shoji Inc., Okayama, Japan, followed by sewing the remaining pair of sides to obtain a temperature increase preventive in the form of a Japanese cushion. The product contains about 150 g of trehalose.

By placing in the fireproof container of the present invention, as well as in conventional containers and others for storing and transporting, constructions, and a room thereof, the product will effectively prevent the inner temperature increase of the above products when exposed to heating conditions such as fire.

### EXAMPLE 7

### Temperature Increase Preventive

A rectangular cotton sheet (cotton count No. 10), having about 20-cm on a longer side and about 9-cm on a shorter side, where the two longer sides were sewed together and either of a pair of the shorter sides was sewed to form a bag-shaped product which was then injected with “TREHA®”, a hydrous crystalline trehalose powder commercialized by Hayashibara Shoji Inc., Okayama, Japan, followed by sewing the remaining pair of the shorter sides to obtain a temperature increase preventive in the form of a column. The product contains about 100 g of trehalose.

By placing in the fireproof container of the present invention, as well as in conventional containers and others for storing and transporting, constructions, and a room thereof, the product will effectively prevent the inner temperature increase of the above products when exposed to heating conditions such as fire.

### EXAMPLE 8

### Temperature Increase Preventive

A flax (cotton count No. 60) was sewed into an otedama-like bag (a beanbag), having a partial opening part and having about 5-cm in wide, depth and height, which was then injected with a hydrous crystalline tetracyclic saccharide, which had been prepared in conventional manner as disclosed by G. M. Bradbrook in Carbohydrate Research, Vol. 329, pp. 655-665 (2000), followed by sewing the opening part to obtain a temperature increasing preventive in the form of an otedama.

By placing in the fireproof container of the present invention, as well as in conventional containers and others for storing and transporting, constructions, and a room thereof, the product will effectively prevent the inner temperature increase of the above products when exposed to heating conditions such as fire.

### INDUSTRIAL APPLICABILITY

As described above, the present invention was made based on the completely novel self-finding that a fireproof container having both outstandingly advantageous fire resistivity and transportability is obtained by forming the fireproof container comprising a multilayer structure of an outer-, middle- and inner-layers positioning in this order from the outside to the inside portions thereof, wherein in the multilayer structure a layer as the outer layer comprising a fire-resistant insulating material having a bulk specific gravity of not higher than 1.0 g/cm³, which has not been used as a partial structure for fireproof containers, is employed in combination with both a layer as the middle layer comprising a material having an air-spaced layer and/or endothermic property, and a layer as the inner layer comprising an incombustibility material having a bulk specific gravity of not higher than 2.0 g/cm³. The fireproof container of the present invention is advantageously useful for storing articles to which conventional fireproof containers are applied, and others including art products whose quality deterioration should be avoided. In addition, the structure of the fireproof container disclosed by the present invention can be used in fireproof containers for storing articles for personal and business uses, and are applicable to containers for transporting articles such as suitcases and containers, as well as to the structures for the whole or a room(s) of constructions, those for enclosing skeleton framings and earthquake-resistive devices in constructions, those for the bodies of automobiles, ships, and airplanes; and others for the body of spaceships used repeatedly in traveling between the inner and outer atmosphere.

The present invention having such advantageous functions and effects is a significant invention that will greatly contribute to this art.

1. A fireproof container characterized in that it comprises a container portion having partially an opening part and a lid means capable of sealing said opening part to keep the inner space of said container portion in a sealed condition and optionally capable of making the inner space into an open condition, said container portion being constructed by a multilayer structure comprising at least three outer-, middle- and inner-layers positioning in this order from the outside to the inside of the container portion, wherein in said multilayer structure said outer layer comprises a fire-resistant insulating material having a bulk specific gravity of not higher than 1.0 g/cm³, said middle layer comprises a material having an air-spaced layer and/or endothermic property, and said inner layer comprises an incombustibility material having a bulk specific gravity of not higher than 2.0 g/cm³.

2. The fireproof container of claim 1, wherein said outer layer has a bulk specific gravity of not higher than 0.5 g/cm³.

3. The fireproof container of claim 1 or 2, wherein said inner layer has a bulk specific gravity of 0.5-1.5 g/cm³.

4. The fireproof container of claim 1, 2 or 3, wherein said outer layer has an adiabatic property that exhibits a thermal conductivity of 0.15 W/(m·K) at 600° C.

5. The fireproof container of any one of claims 1 to 4, wherein said middle layer comprises a material having an endothermic property and being an organic material having an endothermic property.

6. The fireproof container of claim 5, wherein said organic material is a saccharide.

7. The fireproof container of claim 6, which exhibits an endothermic property at a temperature in the range of about 80 to about 200° C.

8. The fireproof container of claim 6 or 7, wherein said saccharide is in a hydrous form.

9. The fireproof container of claim 6, 7 or 8, wherein said saccharide is a hydrous crystalline trehalose.

10. The fireproof container of any one of claims 1 to 9, which further comprises a moistureproof layer positioning between said outer- and said middle-layers.

11. The fireproof container of any one of claims 1 to 10, wherein said multilayer structure further comprises an outermost layer made of a metal, ceramic or moisture-permeable material.

12. The fireproof container of claim 11, wherein said outermost layer is a metal- or ceramic-layer with partial but not complete surface attachment to said outer layer.

13. The fireproof container of any one of claims 1 to 12, wherein said lid means comprises a layer corresponding to said outer layer.

14. The fireproof container of claim 13, wherein said lid means further comprises either or both of layers corresponding to said middle- and said inner-layers.

15. The fireproof container of claim 13 or 14, wherein said lid means further comprises either or both of layers corresponding to said moistureproof- and said outermost-layers.

16. The fireproof container of any one of claims 1 to 15, which has fire-resistive ability of keeping the inner temperature of said container portion at a temperature of 165° C. or lower when subjected to the 1-hour standard heat test specified in JIS S 1037:1998, Fire-resistive container(s), in Japanese Industrial Standards, revised on Mar. 20, 1998, and published by Japanese Standards Association.

17. The fireproof container of any one of claims 1 to 16, which is used as a container for transporting articles.

18. A fireproof refractory panel, which comprises a structure corresponding to said multilayer structure comprising the outer-, middle- and inner-layers that form said container portion of any one of claims 1 to 9.

19. The fireproof refractory panel of claim 18, which further comprises a layer corresponding to said moistureproof layer of claim 10 and/or a layer corresponding to said outermost layer of claim 11 or 12.

20. The fireproof refractory panel of claim 18 or 19, which is used as a material for fireproof containers, another containers for transporting articles, constructions, or for the body of spaceships.

21. An agent for inhibiting the increase of temperature, comprising a saccharide as an effective ingredient.

22. The agent of claim 21, which exhibits an endothermic property at a temperature in the range of about 80 to about 200° C.

23. The agent of claim 21 or 22, wherein said saccharide is in a hydrous crystalline form.

24. The agent of claim 21, 22 or 23, wherein said saccharide is a hydrous crystalline trehalose.

25. The agent of any one of claims 21 to 24, which is injected in a bag formed with a material having moisture-permeability and/or flexibility.

26. A container for storing articles, comprising said agent of any one of claims 21 to 25.

27. A structure for inhibiting the increase of temperature, comprising, at least as a part, said agent of any one of claims 21 to 25.

28. The structure of claim 27, which is in the form of a panel, sheet, container or bag.
